(19) United States
(12) Patent Application Publication
(10) Pub. No.: US 2016/0238237 A1
(43) Pub. Date: Aug. 18, 2016

(54) Illumination Device, Including System and Method of Use

(71) Applicants: Preston Palmer, Gilbert, AZ (US); Wesley Palmer, Mesa, AZ (US); Larkin Palmer, Payson, AZ (US)

(72) Inventors: Preston Palmer, Gilbert, AZ (US); Wesley Palmer, Mesa, AZ (US); Larkin Palmer, Payson, AZ (US)

(21) Appl. No.: 15/136,685

(22) Filed: Apr. 22, 2016

Related U.S. Application Data
(63) Continuation-in-part of application No. 14/557,362, filed on Dec. 1, 2014.
Application No. 14/557,362 is a continuation-in-part of application No. 13/407,443, filed on Feb. 28, 2012, now abandoned.
(60) Provisional application No. 61/464,115, filed on Feb. 28, 2011.

(51) Int. Cl. F21V 33/00; H02J 9/06; F21S 9/02; F21V 7/00; F21V 7/22; H05B 37/03

(52) U.S. Cl. CPC F21V 33/0076; F21V 7/22; H05B 37/03; F21S 9/02; F21V 7/0008; H02J 9/061

(57) ABSTRACT

Disclosed is a battery interconnected illumination device and system. The system includes one or more illumination devices wired into a dedicated circuit with a single location housing a DC power backup source, such as a rechargeable DC battery. The DC power backup source may be replaceable or rechargeable with DC current from an AC-DC transformer-rectifier, a photovoltaic cell, or other means. An electrical relay within the system provides a current to the dedicated circuit by selecting between the line-voltage alternating current source and the DC power backup. A light source of the illumination device is mounted on a mounting surface, such as a ceiling or building wall, by a mounting plate which forms a gap between the light source and the mounting surface. When activated, the light source shines light onto the mounting surface, illuminating the space with low-glare indirect reflected light.

### CROSS REFERENCE TO RELATED APPLICATION

This application is a continuation-in-part of U. S. patent application to Preston Palmer et al. entitled “CENTRAL BATTERY INTERCONNCECTED SMOKE DETECTOR SYSTEM WITH SINGLE WIRE AC AND DC PASS-THROUGH RELAY,” Ser. No. 14/557,362, filed Dec. 1, 2014, which is in turn a continuation-in-part of U.S. patent application to Preston Palmer et al. entitled “CENTRAL BATTERY INTERCONNCECTED SMOKE DETECTOR SYSTEM WITH SINGLE WIRE AC AND DC PASS-THROUGH RELAY,” Ser. No. 13/407,443, filed Feb. 28, 2012, which claims priority to the U.S. Provisional Patent Application to Preston Palmer et al. entitled “CENTRAL BATTERY INTERCONNCECTED SMOKE DETECTOR SYSTEM WITH SINGLE WIRE AC AND DC PASS-THROUGH RELAY,” Ser. No. 61/464,115, filed Feb. 28, 2011 the disclosures of which are hereby incorporated entirely herein by reference.

### BACKGROUND OF THE INVENTION

1. Technical Field

This invention relates to devices that provide illumination. In particular, disclosed embodiments of the invention relate to a reflective backup illumination device, including a system comprising a plurality of devices and a method of use for providing backup illumination of a space with reflected light.

2. State of the Art

Multiple devices and systems exist for providing emergency lighting in the event of loss of electrical power provided by a public utility company or other power source external to a building. In some cases, a light source to provide lighting for safe egress of persons present in a building space during an emergency, such as a house or building fire, is present in a detection and alert device. A conventional smoke detector is one representative example of a detection and alert device. To be maximally effective in minimizing injuries and death, however, a system of alert devices, such as smoke detectors, must 1) be functional; and 2) provide a source of light to illuminate a space for safe egress in the event of a power failure.

Regarding the importance of maintaining a reliable system of smoke detectors, functional smoke detectors in a home or commercial building save lives. In the U.S., many states require smoke alarms/detectors in both residential and commercial buildings, particularly in new construction. Current smoke detector alarm systems vary in the manner through which the individual detectors are interconnected and powered. Most commonly, smoke detectors are wired into an isolated alternating current (“AC”) power circuit (“dedicated circuit”) in a residential or commercial building to provide a reliable, continuous source of power. In the event of a power failure wherein the dedicated circuit is no longer energized with an external current from a remote AC power source, a conventional DC battery within each detector provides backup power to the device. This generally works fine, unless these backup-power batteries fail or are disconnected. According to the National Fire Protection Association (“NFPA”), almost two-thirds of home fire deaths from 2000-2009 resulted from fires in homes without smoke detector alarms or in homes where smoke detector alarms were non-functioning. The NFPA reports that eighty percent of smoke alarm failures during this period arose from a missing or disconnected battery, dead or discharged battery, or when line AC power fails, is/shut-off, or otherwise is disconnected. When the voltage of a backup direct current (“DC”) battery in an individual smoke detector weakens, a typical detector emits an audible alarm consisting of regular, loud beeps or chirps, alerting the building's occupant to replace the old, discharged battery with a fresh one.

Additional problems exist with these conventional devices beyond failure of backup power. For example, available emergency lighting devices provide for direct lighting of a space with a backup emergency light source. The light from the light source may effectively illuminate the portion of the space surrounding the spot upon which the light shines directly, while failing to effectively illuminate a larger area. Additionally, direct light often creates glare, particularly if the direct light is a white light. The effect is frequently to glaringly illuminate a small portion of the space while effectively “blinding” a building occupant to surrounding, dimly lit areas of the space.

Accordingly, what is needed is a system of backup illumination devices that simultaneously: 1) provides a backup power source to interconnected illumination devices in a residence or commercial building; 2) monitors the functionality of each individual backup and illumination device; and 3) provides a reliable source of emergency backup lighting which effectively illuminates a large space without glare.

### DISCLOSURE OF EMBODIMENTS OF THE INVENTION

This invention relates to illumination devices. In particular, embodiments of the invention relate to a system comprising illumination devices and a method of creating the same for providing glare-free illumination of a space to allow for egress or other activities in a variety of situations, including emergency and other potentially dangerous situations. The system additionally provides direct current (“DC”) backup power through a dedicated circuit to an interconnected system of illumination devices installed in a residential or commercial building.

The illumination devices and system include alert and illumination devices, detection and illumination devices, and detection and alert illumination devices, in some embodiments.

Disclosed is an illumination device comprising a device comprising a light source; a first circuit powered by an alternating current; a second circuit powered by a direct current electrically coupled to the light source, a back plate coupled to the device; and a gap interposed between the device and the back plate, wherein a light from the light source is directed across the gap onto a mounting surface coupled to the back plate, causing illumination of a space in response to directing the light onto the mounting surface.

In some embodiments, the mounting surface is reflective. In some embodiments, the illumination device further comprises a dedicated circuit electrically coupled to the first circuit and to the second circuit. In some embodiments, the reflected light comprises a green light. In some embodiments, the reflected light is a green light comprising a wavelength of between about 470 nanometers and about 580 nanometers. In some embodiments, the gap is between about one millimeter and about 15 centimeters. In some embodiments, the light source comprises an annular light source. In some embodiments, the device comprises a detection and alert device.

Disclosed is a method of use for an illumination device comprising the steps of activating an illumination device comprising a light source; directing a light from the illumination device onto a mounting surface across a gap between the illumination device and the mounting surface; and illuminating a space in response to the light reflecting off the mounting surface.

In some embodiments, the mounting surface comprises a reflective coating. In some embodiments, the illumination device is coupled to a building structure comprising a dedicated circuit, wherein the illumination device is electrically coupled to the dedicated circuit. In some embodiments, the method further comprises a step synchronizing a pattern of pulsed vibrations and pulsed illuminations, wherein the illumination device comprises a pulsed vibrational source and wherein the light source is a pulsed light source, which communicates a condition to a person perceiving the synchronized pattern of pulsed vibrations caused by the pulsed vibrational source and the pattern or pulsed illuminations caused by the pulsed light source.

Disclosed is an illumination device system comprising an illumination device comprising a light source; an alert device; and a mounting surface, wherein the illumination device directs a light from the light source onto the mounting surface forming a reflected light, causing illumination of a space with the reflected light.

In some embodiments, the alert device comprises a visual alert. In some embodiments, the visual alert is a pulsed visual alert. In some embodiments, the alert device comprises a vibrational alert. In some embodiments, the vibrational alert is a pulsed vibrational alert. In some embodiments, the illumination device system further comprises a pulsed visual alert and a pulsed vibrational alert, wherein the pulsed visual alert is synchronous with the pulsed vibrational alert.

In some embodiments, the alert device comprises an auditory alert. In some embodiments, the illumination device comprises a detection and alert device.

Disclosed is an illumination system comprising a dedicated circuit electrically coupled to an alternating current and a direct current, wherein under a condition with the alternating current present, the dedicated circuit is energized with the alternating current; a first relay electrically coupled to each of the dedicated circuit, the alternating current, and the direct current, wherein under a condition with the alternating current absent, the first relay causes the direct current to energize the dedicated circuit; an illumination device electrically coupled to the dedicated circuit, comprising a light source; a first circuit powered by the alternating current; a second circuit electrically coupled to each of the first circuit and the light source, wherein the second circuit energizes the light source; a back plate coupled to the illumination device; and a gap interposed between the illumination device and the back plate, wherein the gap separates the illumination device from a mounting surface, and wherein a light from the light source is directed across the gap onto the mounting surface and reflected by the mounting surface, causing illumination of a space with a reflected light.

In some embodiments, a battery coupled to the dedicated circuit energizes the dedicated circuit with the direct current. In some embodiments, the illumination system further comprises a detection and alert device electrically coupled to the dedicated circuit; a plurality of illumination devices electrically coupled to the dedicated circuit, and a low voltage controller coupled to the dedicated circuit, wherein the low voltage controller responds to activation of the detection and alert device by activating the plurality of backup illumination devices.

The foregoing and other features and advantages of the invention will be apparent to those of ordinary skill in the art from the following more particular description of the invention and the accompanying drawings.

### BRIEF DESCRIPTION OF THE DRAWINGS

FIG. 1 is a schematic view of an illumination device system 100;

FIG. 2 is a schematic view of an additional embodiment of an illumination device system 100;

FIG. 3 is a schematic view of an another additional embodiment of an illumination device system 100;

FIG. 4 is a schematic view of a low voltage controller 350 of an illumination device system 100;

FIG. 5 is a schematic representation of two illumination devices 160 electrically coupled to dedicated circuit 102;

FIG. 6 is a schematic representation of an illumination device 160;

FIG. 7 is an additional schematic representation of an illumination device 160;

FIG. 8a is a side view of an illumination device 160 coupled to a mounting surface;

FIG. 8b is an exploded side view of an illumination device 160 coupled to a mounting surface;

FIG. 9 is a schematic representation of a method of use for an illumination device; and

FIG. 10 is a schematic representation of an additional embodiment of the method of use for an illumination device.

### DETAILED DESCRIPTION OF EMBODIMENTS OF THE INVENTION

As discussed above, the disclosed invention relates to an illumination device system with a remotely located DC battery power backup to provide illumination, such as backup emergency lighting during a power failure or emergency, for persons present in a building space during a failure of AC power and during potentially dangerous situations. In the event of an AC power failure, an illumination device system transmits power from a reliable, continuous DC backup source to one or a plurality of illumination devices electrically coupled to a dedicated circuit, eliminating the need for a DC battery within each individual illumination device.

Existing illumination device systems for commercial buildings, such as hospitals, for example, use community-distributed AC power with an AC backup, such as a diesel generator. Smaller commercial buildings and single-family homes often have installed devices to provide emergency lighting. In some homes, a detection and alert device, such as a smoke detector, for example, provides a source of emergency lighting in the form of a light source powered by a separate nine-volt battery housed within each individual detection and alert device.

This ubiquitous system utilizing a different battery in each individual alert device is inadequate. When an individual device's battery is charged and functioning, the backup system works well. Problems arise, however, when a battery ages, loses its charge, and eventually fails. When the battery voltage drops below a given level, a conventional alert device will emit a periodic audible alarm, such as a loud “chirp.” If the building housing the detector is occupied, this alarm is usually effective at getting the occupants' attention. When the occupant or owner is severely hearing impaired, an audible alarm is not heard. Either way, a responsible occupant or building owner will respond by simply replacing the old, discharged battery with a new, fresh battery.

All too often, however, this does not happen for two general reasons. The first reason is because changing the battery in even one standard alert and illumination device is inconvenient. Devices are usually mounted on a ceiling and require at least a step-stool, if not a tall ladder, for access. Even a small residence will have three or four alert and illumination devices; a large house may have up to a dozen or more. Therefore, a typical building will house multiple illumination devices in difficult-to-access locations, each with a different battery which will fail and require replacement in its own time, different from all the other batteries. Some occupants change each battery as it fails. Others change all the individual device batteries when one device battery fails, resulting in discarding some batteries prematurely creating an unnecessary waste and expense. To avoid future inconvenience, however, many occupants respond to an illumination and alert device's battery-failure alarm by disabling or removing all of the similar individual alert devices throughout the building.

The second reason is because the building is unoccupied for an extended period of time. Many homes and buildings stand vacant for months or years awaiting sale, or while awaiting renovation or restoration. Buildings unoccupied for a lengthy period often have no AC electrical service. A great many of these buildings are not regularly visited or attended. If functioning alert and illumination devices are present in these buildings, the batteries all fail after an extended period and the building is left without a functioning detection and alert illumination device system.

Also, an illumination device typically shines a white or other broad-spectrum light from a light source directly onto a floor or wall surfaced of a building. This often has the effect of brightly illuminating the surface directly with a white light, causing a glare which tends to blind a person to the surrounding, indirectly illuminated portions of the space.

As used herein, “space,” and “building space” mean any area in proximity to an illumination device which may be illuminated by the device. This includes indoor spaces and outdoor spaces without limitation.

Embodiments of the disclosed invention solve these and other problems by providing an illumination device which provides illumination of a space with indirect, reflected light, whether indoors or outdoors, to allow for safe egress of a person occupying the space in the event of a failure of AC line power or during an emergency situation. The light is reflected off of a surface, such as a wall or ceiling, upon which the illumination device is mounted. The reflected light broadly illuminates a surrounding space with indirect light, wherein glare is minimized and causing a person occupying the space to see a much larger area, compared with direct lighting. Additionally, the distinct character of the indirect light, which may be of a specific color, alerts any person occupying the space to the presence of a possibly dangerous situation, such as a building fire, severe weather, gas leak, and others. Embodiments of the disclosed invention also eliminate the need to monitor and regularly change batteries housed in detection and alert devices located in hard-to-reach locations. The disclosed invention provides a continuous reliable source of backup DC power for detection and alert illumination devices wired into a dedicated circuit.

Disclosed is a battery interconnected illumination device system and method of use. What immediately follows is a general overview of the system. Afterward, additional details are provided in a detailed description of each of the various drawing figures.

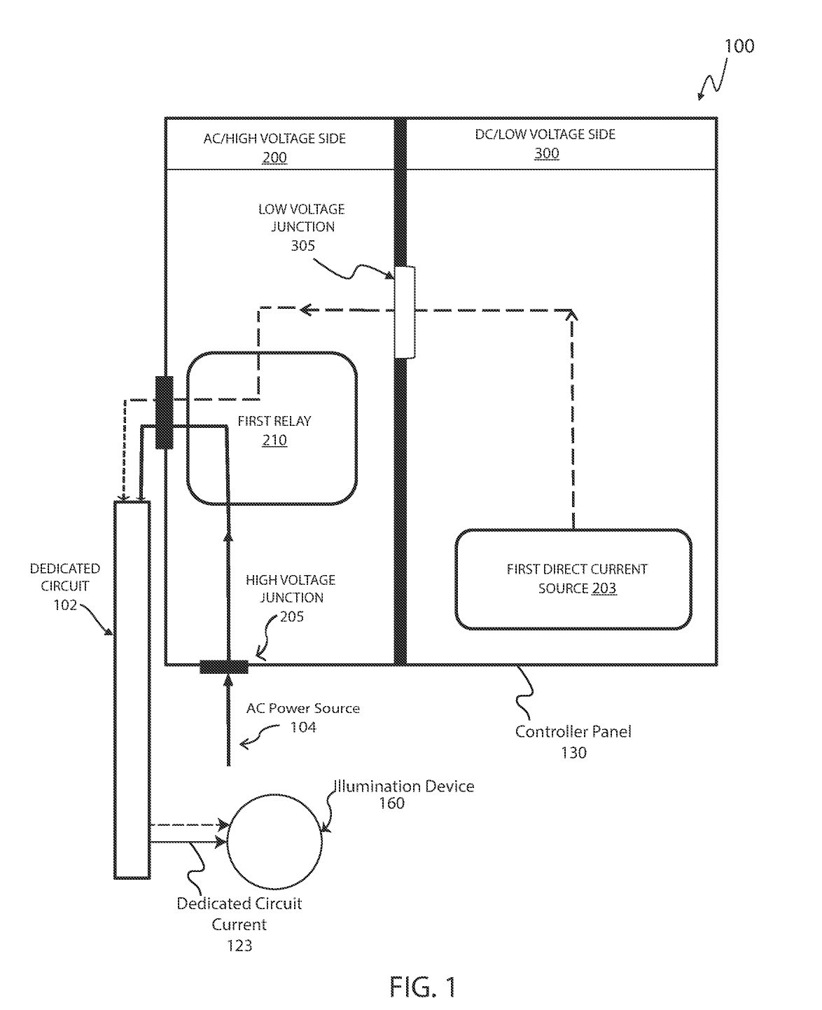

In some embodiments, as shown in FIG. 1, the system generally comprises an AC power source 104, a first DC source 203, a first relay 210, a dedicated circuit 102, and an illumination device 160. Illumination device 160 is powered by a dedicated circuit current 123 conducted by dedicated circuit 102. Dedicated circuit 102, in some embodiments, is a wiring circuit present within a building structure, whether a commercial or a residential building or other structure, which is electrically isolated from other electrical currents in the building structure. Many building structures already comprise a dedicated circuit coupled to a plurality of smoke detectors, as one example of a detection and alert device. Currently, however, a dedicated circuit in an existing building is only coupled to and conducts current from an AC source. Such dedicated circuits are not coupled to and, therefore, do not conduct current from a DC source. Illumination device 160, being electrically coupled to dedicated circuit 102 which may conduct either an AC dedicated circuit current 123 or a DC dedicated circuit current 123 to illumination device 160, therefore, determines whether dedicated circuit current 123 is AC or DC.

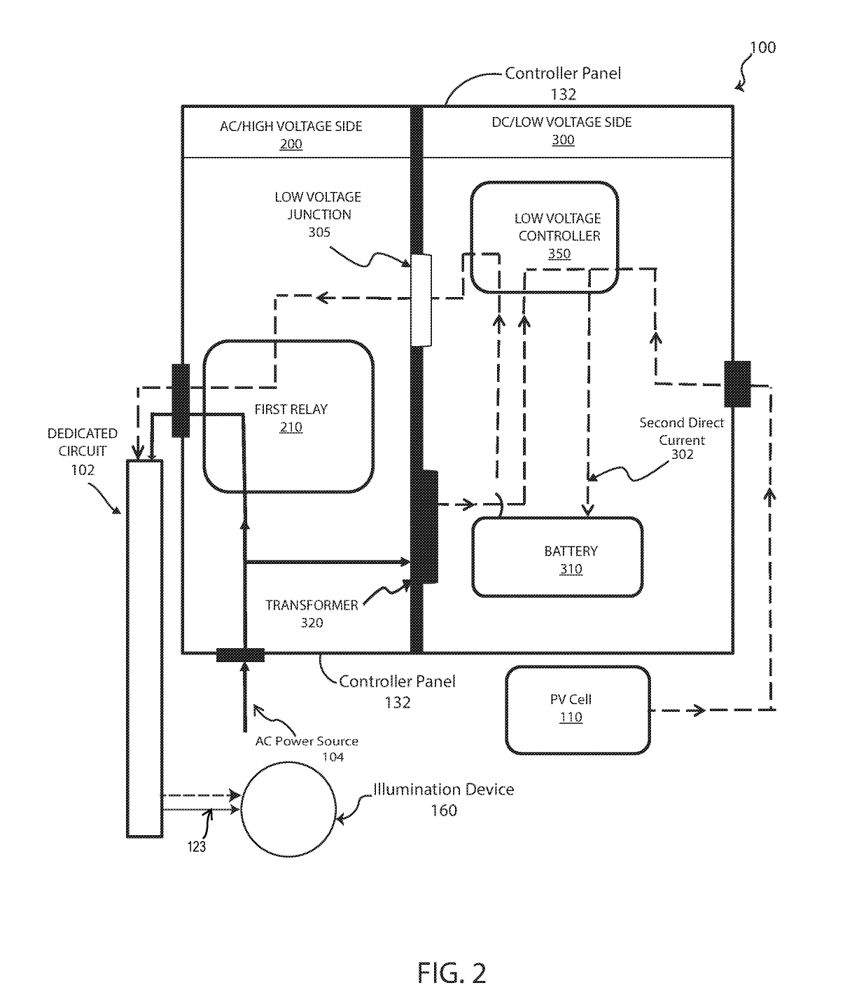

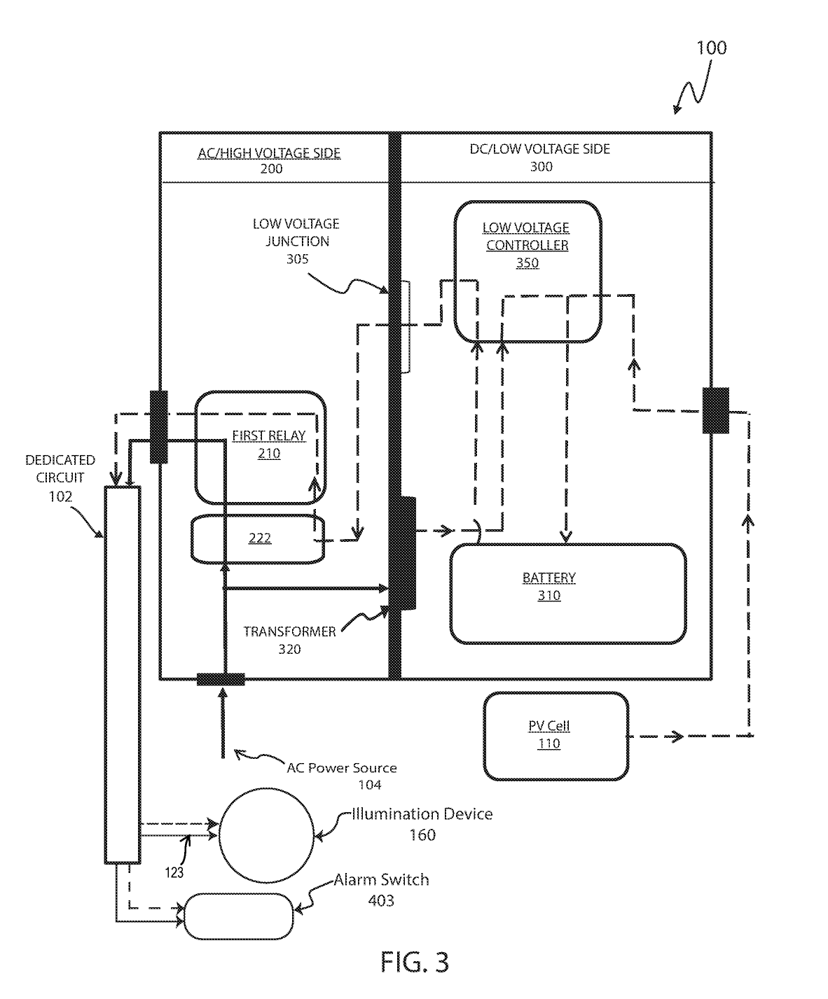

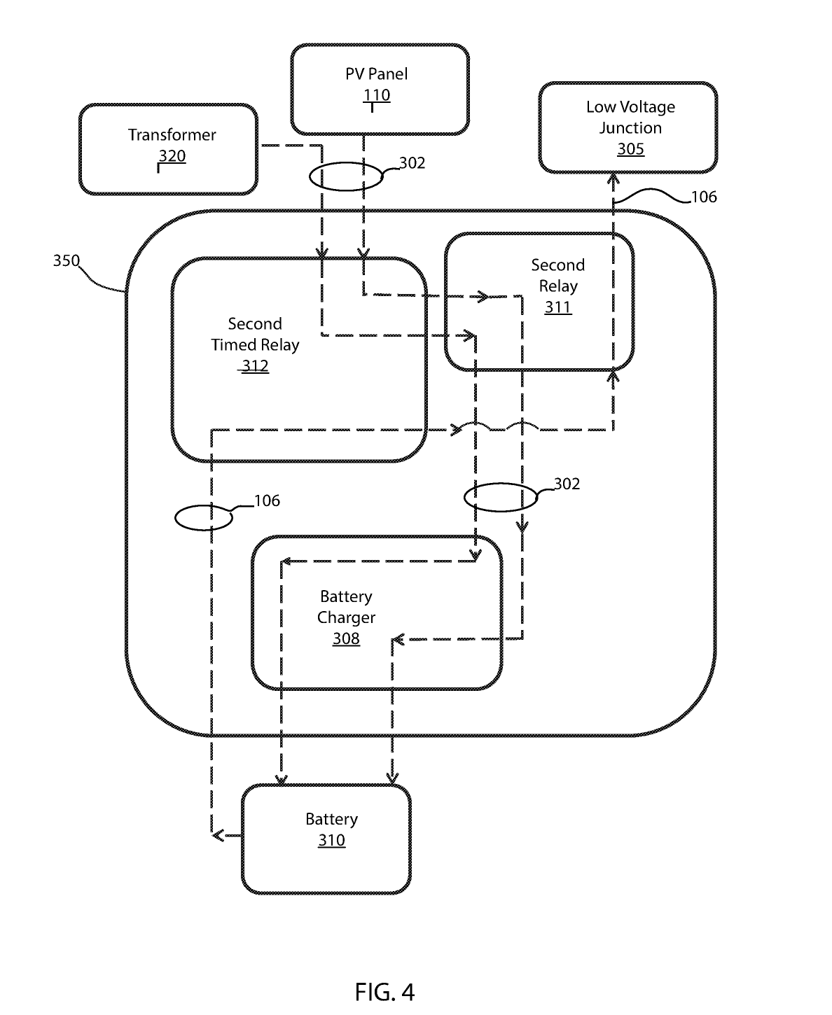

First relay 210 is electrically coupled to an AC power source 104, a first DC source 203, and dedicated circuit 102 coupled to one or a plurality of illumination devices 160. AC power source 104, in some embodiments, derives from a conventional power generation and distribution system. For purposes of this disclosure, the term “line voltage” is used synonymously with AC power source 104. First DC source 203, in some embodiments, is a rechargeable battery 310 (shown in FIG. 2, FIG. 3, and FIG. 4.) In various embodiments, first relay 210 selectively delivers AC electricity from AC power source 104 to detection and alert device(s) 160 through dedicated circuit 102 so long as AC power source 104 is present. When AC power source 104 is absent, such as during a power failure or disconnected service, first relay 210 selectively delivers first DC source 203 to detection and alert devices 160 through dedicated circuit 102. First relay 210, by default, energizes dedicated circuit 102 with AC power, switching to DC battery power when AC power fails or is otherwise absent. When AC power source 104 is absent, first relay 210 delivers DC power from first DC source 203 to detection and alert devices 160 through the same physical wiring—dedicated circuit 102—as is energized with AC from alternating current power source 104 when line voltage is present. In this manner, some embodiments of the invention allow for a single-battery source of back-up DC power to one or a plurality of illumination devices 160, eliminating the need to house a battery within each individual illumination device 160.

A central battery AC/DC controller panel 130, in some embodiments, is located in a convenient location in or immediately outside the building. It is convenient to install controller panel 130 adjacent or near the building's traditional service-entrance electrical panel. Controller panel 130, in some embodiments, houses first DC source 203 and first relay 210. Controller panel 130, in some embodiments, receives AC power source 104 via the building's service entrance panel, typically a circuit breaker box. Controller panel 130, in some embodiments, outputs AC power or direct current, as determined by first relay 210, back to the service entrance panel to energize dedicated circuit 102. Because a first DC source 203, such as a rechargeable DC battery in some embodiments, is housed in a convenient location such as near the service entrance panel within controller panel 130, access to first DC source 203 for service or replacement is safe and uncomplicated. In some embodiments, controller panel 130 is mounted at standing-eye-level, so that a stool, ladder, or the like is not required to access first DC source 203. Therefore, in some embodiments wherein first DC source 203 comprises a rechargeable DC battery, the need for multiple periodic battery changes is eliminated. Some embodiments additionally comprise one or more additional DC sources, such as a photovoltaic cell and/or AC power source 104 current modified by an AC/DC transformer, for example.

FIG. 1 shows an example embodiment of a battery interconnected illumination system 100. System 100 comprises controller panel 130 with an AC/high voltage side 200 and a D/C low voltage side 300, dedicated circuit 102, and illumination device 160. In FIG. 1, and other drawing figures, solid lines connecting components represent electrical connections conducting AC power and dashed lines connecting components represent electrical connections conducting DC power. Arrows on the ends and/or mid-segments of solid and dashed electrical connection lines represent the direction of current flow. AC/high voltage side 200 comprises first relay 210. In the embodiment shown in FIG. 1, alternating current from AC power source 104 enters an AC/high voltage side 200 of system 100 and is electrically coupled to first relay 210. As mentioned above, first relay 210 is also electrically coupled to first DC source 203 and dedicated circuit 102. First DC source 203, in some embodiments, is housed inside DC/low voltage side 300 of system 100 and is discussed in detail below.

In some embodiments, AC/high voltage wiring is physically separated from DC/low voltage wiring within controller panel 130 for safety reasons. In the United States, line AC voltage is 220 volts, stepped-down to 110 volts at the service entrance panel. Contact with high voltage AC power from a typical 110 volt AC power source 104 may, under certain conditions, result in electrocution. Further, the need to access any of system 100's components located in AC/high voltage side 200 should be very infrequent. Conversely, contact with relatively low voltage, such as DC power from a typical 12 volt first DC source 203, in some embodiments, should almost never result in serious injury. Additionally, in some embodiments, first DC source 203 will periodically need replacement, such as when a non-rechargeable DC battery or a rechargeable DC battery comprises first DC source 203. Therefore, controller panel 130, in some embodiments, is constructed so as to physically isolate the relatively safe currents present in DC/low voltage side 300 from the more hazardous currents present in AC/high voltage side 200.

In the embodiments of system 100 shown in FIG. 1, and some other embodiments, wiring carrying DC current from first DC source 203 passes from DC/low voltage side 300 to AC/high voltage side 200 through a low voltage junction 305. Low voltage junction 305, in some embodiments, is any one of a variety of pass-through conduits commercially available and known to those in the art electrically insulated from contact by a physical partition between AC/high voltage side 200 and DC/low voltage side 300 of controller panel 130. Similarly, AC power from AC power source 104 enters AC/high voltage side 200 through a high voltage junction 205. High voltage junction 205, in some embodiments, is any one of a variety of pass-through conduits commercially available and know to those in the art electrically insulated form contact with the physical outer wall of controller panel 130

First relay 210 of system 100, in the embodiment shown in FIG. 1 and some other embodiments, selectively delivers alternating current from AC power source 104 to dedicated circuit 102 so long as AC power is available. In some embodiments, first relay 210 is rated for a 110 V AC input and a 12 V DC input. In some embodiment, first relay 210 is a mechanical relay. In some embodiments, first relay 210 is a solid-state relay. In some embodiments, first relay 210 is selected from a variety of commercially available devices known in the art. Factors affecting the choice of component for first relay 210 include the AC voltage and amperage of the line current entering first relay 210 from AC power source 104. In a default condition where line voltage is present from AC power source 104, first relay 210 conducts AC power to dedicated circuit 102.

Dedicated circuit 102 is an electrical circuit electrically coupled to a single illumination device 160 or an interconnected plurality of illumination devices 160. A dedicated circuit interconnecting smoke detectors comprising a light source, as a non-limiting example of a detection and alert illumination device, has widely been adopted in residential building codes throughout the U.S. since written into the National Fire Alarm Code in 1989. Therefore, dedicated circuit 102 is generally present in all newer residential buildings and widely known to those with skill in the art.

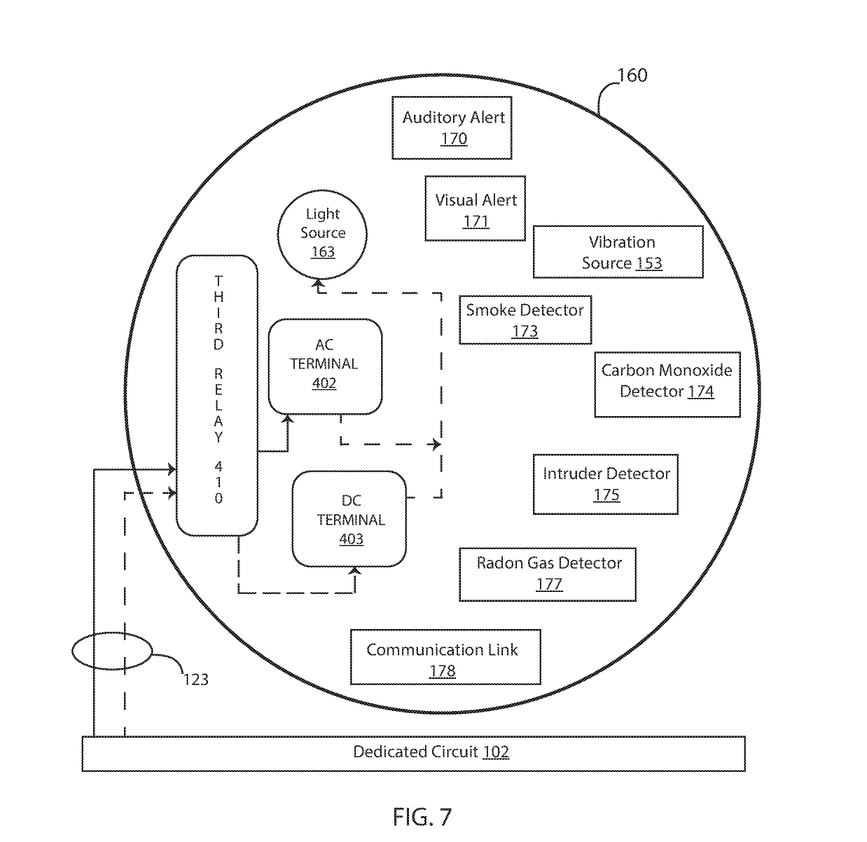

Illumination device 160 with vibrational alert is compatible with a conventional dedicated circuit, such as dedicated circuit 102 shown in FIG. 1, in some embodiments. An existing dedicated circuit installed in a building structure conducts either AC or DC, such as from AC power source 104, first DC source 203, or a second direct current 302 (See FIG. 2) to illumination device 160. DC from either first DC source 203 or second DC 302 is also sufficient to power a vibration source 153 (See FIG. 7). Electrically coupling illumination devices 160 to dedicated circuit 102 interconnects the devices and enables simultaneous activation of all illumination devices 160 electrically coupled to dedicated circuit 102 when a single illumination device 160 is activated, in some embodiments. In some embodiments, an alarm switch 403 is electrically coupled to dedicated circuit 102 (See FIG. 3).

When AC power source 104 is absent, first relay 210 delivers DC power from first DC source 203 to illumination devices 160 through the same physical wiring—dedicated circuit 102—as is energized with AC from AC power source 104 when line voltage is present. Although dedicated circuit 102 is energized with AC power when AC power is available, dedicated circuit 102 is able to conduct sufficient DC to energize a plurality of illumination devices 160 along the limited lengths of wire present in a residential or small commercial building without a substantial voltage drop across the internal electrical resistance in the wires of dedicated circuit 102. Further, because dedicated circuit 102 is only coupled to illumination devices 160 and, in some embodiments, alarm switch 406 but no other electrical loads, electrical resistance is minimized and available voltage is conserved. Therefore, when line AC is not available, first relay 210 completes a circuit to first DC source 203, wherein dedicated circuit 102 is powered by first DC source 203. First DC source 203 provides adequate DC power to energize a plurality of illumination devices 160 electrically coupled to dedicated circuit 102 without a drop in voltage below the operational threshold voltage of illumination devices 160.

FIG. 1 also shows dedicated circuit 102 carrying a dedicated circuit current 123 to illumination device 160. As discussed, when an AC power source 104 is present, dedicated circuit current 123 is AC. When AC power source 104 is absent, dedicated circuit current 123 is DC. FIG. 1 shows dedicated circuit current 123 as two electrical connections, one DC and one AC. This is merely a schematic representation; the same physical wiring conducts either AC power or DC power, depending upon whether AC power source 104 is present. First relay 210 selectively chooses whether to energize dedicated circuit 102 with DC power depending upon the availability of AC power from AC power source 104 as discussed.

FIG. 2 shows an example embodiment of battery interconnected illumination device system 100. In the embodiment shown in FIG. 2, and in some other embodiments, a battery 310 is first DC source 203. Battery 310, in some embodiments, is a non-rechargeable DC battery, such as a 12 volt dry cell “lantern” battery. In some embodiments, battery 310 is two 6 volt dry cell batteries electrically connected in series to deliver 12 volts. In still other embodiments, battery 310 is some other non-rechargeable battery or a combination of batteries such that the total available voltage and current provided by battery/batteries 310 result in a first DC source of sufficient voltage and available current to power the building's system of illumination devices 160 interconnected on dedicated circuit 102. Some advantages of using a non-rechargeable battery 310 as first DC source 203 are low cost and a more simple design. One disadvantage is the limited useful life of a non-rechargeable battery before it needs to be replaced. Another disadvantage is failure of a non-rechargeable battery 310 as available backup DC power (i.e., first DC source 203) to battery interconnected alert device system with vibrational alert 100 in a building which has been abandoned or otherwise unattended for a long period of time.

In some embodiments, battery 310 is a rechargeable battery. The use of a rechargeable battery 310 versus a non-rechargeable battery 310 is advantageous in some embodiments of system 100 which provide an automatic recharging means, such as the non-limiting example embodiment of system 100 shown in FIG. 2 and discussed further herein below. A rechargeable battery has a longer useful life than a non-rechargeable battery. In some embodiments of system 100 wherein battery 310 comprises a rechargeable battery, additional components comprising an automatic recharging means provide for a first DC source 203, such as a rechargeable battery 310 for example, to provide potentially years of continuous DC power to illumination devices 160 in a completely unattended building wherein AC power source 104 is continuously unavailable, or unavailable for extended periods. In some embodiments, rechargeable battery 310 is a UB 1250 12 volt sealed lead-cell battery. This is by way of example only. In some embodiments, battery 310 is a rechargeable lead cell, nickel-cadmium, lithium hydride, or any other suitable battery, whether rechargeable or not. Many other suitable examples are commercially available and known to those skilled in the art.

FIG. 2 additionally shows a means for recharging battery 310 of system 100 with a second DC current 302. In the embodiment of system 100 shown in FIG. 2 and in some other embodiments, DC/low voltage side 300 further comprises a low voltage controller 350, a transformer 320, and a photovoltaic (“PV”) cell 110. In this embodiments, low voltage controller 350 selects second DC source 302 from a plurality of sources, such as PV cell 110 or AC power source 104 modified by transformer 320, for example. In the example embodiment shown in FIG. 2, low voltage controller 350 is electrically coupled to PV cell 110, transformer 320, battery 310, and first relay 210. In some embodiments, low voltage controller 350 selects and routes DC power from second DC source 302 to recharge battery 310. In some embodiments, low voltage controller also routes DC from first DC source 203, such as battery 310 in the embodiment shown, to first relay 210.

In some embodiments, low voltage controller 350 selects a DC charging current output from a plurality of available second direct current 302 inputs. In the example embodiment shown by FIG. 2, low voltage controller 350 conducts DC from transformer 320 to charge battery 310 under conditions where AC power source 104 is present. Under conditions where AC power source 104 is not present, such as a power outage or disconnection of service, low voltage controller 350 conducts DC from PV cell 110, provided that DC is available from PV cell 110. In some embodiments, low voltage controller comprises a battery charging means to regulate DC delivered to battery 310 by monitoring the charge state of battery 310. Such a charging means functions to maximize the charge status and extend the useful life of battery 310. Consequently, battery 310 remains fully charged by low voltage controller 350 under conditions where either AC power source 104, sunlight, or both are available in some embodiments, including the embodiment shown in FIG. 2.

Transformer 320, in some embodiments, is an AC/DC step-down transformer operating between 110 volt AC and 12 volt DC voltages. Additionally, transformer 320 receives 110 volt AC line input power to 12 volt DC power for recharging battery 310, in some embodiments. Transformer 320 may be selected from a variety of commercially available AC/DC step-down voltage transformers to operate between different ranges of AC and DC voltages and amperages depending upon the characteristics of AC power source 104 and the parameters under which low voltage controller 350 recharges battery 310. These parameters, in turn, depend upon the charging requirements of battery 310.

In some embodiments, PV cell 110 is a photovoltaic cell electrically coupled to low voltage controller 350. PV cell 110 provides threshold DC amperage at 12 volts to generate a charging current 302 for battery 110 under conditions where PV cell 110 is exposed to adequate incident sunlight. Many suitable examples of photovoltaic cells for use as PV cell 110 are commercially available and may be used in various embodiments of the invention. In some embodiments, PV cell 110 is a relatively small photovoltaic cell, 12 inches to 18 inches by 24 inches, for example, which is secured in a sunlit indoor location, such as an un-shaded southern-facing window, to deter theft or vandalism, in some embodiments. In some embodiments, PV cell 110 is secured in an outdoor location. In some embodiments, PV cell 110 is mounted on the outside of a controller panel 132. In some embodiments, PV cell 100 is secured to the building's outer wall, a rooftop, a stand-alone mounting pole, a fence, an out-building or any other suitable outdoor location exposed to sunlight.

In some embodiments (not shown in the drawing figures), first DC source 203 comprises PV cell 110. In these and some other embodiments, low voltage controller 350 conducts DC power from PV cell 110 directly through low voltage junction 305 to first relay 210 when DC power at a threshold voltage is generated by PV cell 110.

FIG. 3 shows an example embodiment of battery interconnected illumination device system 100. FIG. 3 shows all the elements of system 100 shown in FIG. 2 with the addition of a first timed relay 222 and an alarm switch 403.

Electrically interposing first timed relay 222, shown in FIG. 2, between AC power source 104 inputting to dedicated circuit 102 through first relay 210, in some embodiments, allows high voltage charge present within capacitors and other electronic components of illumination device 160, dedicated circuit 102, and first relay 210 at the instant preceding cessation of the external current from AC power source 104 to dissipate charge for a time interval prior to re-energizing these elements with low voltage DC power from first DC source 203. Additionally, first timed relay 222, in some embodiments, is a mechanism to increase safety by minimizing or eliminating any risk of electrical arcing or interference between AC and DC in the same circuit. The use of first timed relay 222, a second timed relay 312 (See FIG. 4), and third timed relay 422 (not shown in the drawing figures) in some embodiments, is by example only. Other electronic components, such as resistors or diodes, for example, may be used in system 100 to accomplish the same or similar function.

First timed relay 222 is electrically coupled to AC power source 104, low voltage controller 350, and first relay 210. In some embodiments, first timed relay 222 is a mechanical relay. In some embodiments, first timed relay 222 is a solid state relay. First time relay 222 is electrically interposed between AC and DC input currents and first relay 210 to provide a timed delay between termination of AC power and transmission of DC power from low voltage controller 350 to first relay 210. In some embodiments, this is a one second delay. In some embodiments, this delay is between 500 milliseconds and one second. In some embodiments, this delay is shorter than 500 milliseconds. In some embodiments, this delay is longer than one second. First timed relay 222 may be selected from mechanical or solid-state relays that are commercially available and known to those with skill in the art.

In some embodiments, alarm switch 403 is electrically coupled to dedicated circuit 102, wherein manual activation of alarm switch 403 causes activation of illumination devices 160. In some embodiments wherein illumination device 160 comprises a detection and alert device with vibrational alert, manual activation of alarm switch 403 causes activation of a vibrational alert, an audible alert, or both a vibrational alert and an audible alert. Alarm switch 403 allows for manual activation of system 100 by an occupant of a building structure wherein system illumination device 160 is installed, causing illumination device 160 to provide emergency illumination to persons other person present within a building space.

FIG. 4 shows a detailed schematic representation of an example embodiment of low voltage controller 350. Low voltage controller 350 has two functions. First, low voltage controller 350 functions to direct a charging second direct current 302 to battery 310 from a plurality of second direct currents 302. In some embodiments, second direct current 302 comprises AC power source 104 modified by transformer 320, such as to rectify an AC current to a DC current, and to either increase or decrease the voltage of the DC current. In some embodiments, second DC source 302 comprises PV panel 110. In still other embodiments, second direct current 302 comprises a direct current not described herein. Any combination of one, two, three, or more than three second direct currents 302 are electrically coupled to low voltage controller 350 in various embodiments of the invention. Battery 310 supplies first direct current 106 to low voltage junction 305, via second relay, in some embodiments. In some embodiments, second timed relay 312 in electrically interposed in first direct current 106 between battery 310 and second relay 311.

Second, low voltage controller 350 functions to route DC power from battery 310 directly to first relay 210 or indirectly through first timed relay 222, depending on whether the embodiment comprises first timed relay 222.

In the example embodiment shown in FIG. 4, low voltage controller 350 comprises second relay 311, second timed relay 312, and a battery charger 308. Battery charger 308, in some embodiments, comprises a commercially available DC battery charger/inverter which uses DC current from PV panel 110, or AC current from transformer 320 (changed to DC current by the inverter). Low voltage controller 350 is electrically coupled to battery 310, transformer 320, and/or PV panel 110. This arrangement is not meant to be limiting. Any number and combination of electrical/electronic devices can be assembled to perform the two functions disclosed herein above. For example, low voltage controller 350 may simply comprise a unitary solid state device such as a commercially available DC-DC power management integrated circuit known to those skilled in the art.

In the embodiment shown in FIG. 4, battery 310 is electrically coupled to second timed relay 312 of low voltage controller 350. Second timed relay 312 functions in a manner analogous to first timed relay 222 discussed herein above. In some embodiments, second timed relay 312 is electrically interposed between battery 310 and second relay 311 and creates a timed delay between termination of DC power from transformer 320 and transmission of DC power from battery 310 to second relay 311. In some embodiments, this second timed relay 312 creates about a one second delay between arrival of DC from battery 310 and provision of DC to second relay 311. In some embodiments, the delay is between about 500 milliseconds and about one second. In some embodiments, the delay is shorter than about 500 milliseconds. In some embodiments, the delay is longer than about one second. Second timed relay 312 may be selected from mechanical or solid-state relays that are commercially available and known to those with skill in the art. In some embodiments (not shown), second timed relay 312 is not present and battery 310 is electrically coupled directly to second relay 311.

When no AC power source 104 is available, DC power from battery 310 is routed through low voltage junction 305 to AC/high voltage side 200 (See FIG. 1.)

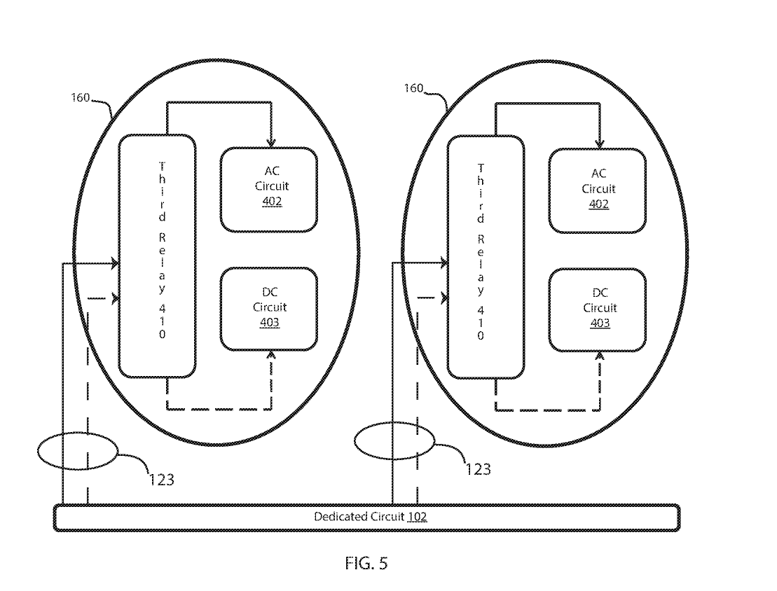

FIG. 5 shows a schematic representation of two illumination devices 160 electrically coupled to dedicated circuit 102. This illustration is by example only and not meant to be limiting. One, three, or any number of illumination devices 160 are electrically coupled to dedicated circuit 102 in some of the various embodiments of the invention.

In some embodiments, illumination devices 160 comprises an AC circuit 402 electrically coupled to third relay 410. In such embodiments, an example of which is shown in FIG. 5, third relay 410 is coupled to dedicated circuit current 123 comprising external AC power. Third relay 410 is also coupled, in some embodiments, to a DC circuit 403. In some embodiments of the invention, illumination device 160 comprises a third relay 410 electrically coupled to an AC circuit 402 of illumination device 160 and a DC circuit 403, such as the 9 volt battery terminal similar to that found in a commercially available smoke detector. In some embodiments, third relay 410 is absent from illumination device 160 and dedicated circuit current 123, either AC or DC, is provided illumination device 160 via dedicated circuit 102.

As shown in FIG. 5, illumination device 160 comprises third relay 410 (in some embodiments), an AC circuit 402 and a DC circuit 403. In some embodiments (not shown) illumination device 160 may comprise a third timed relay. A third timed relay is, however, generally not necessary because any interruption in AC power from AC current source 104 is followed by a short delay created by first timed relay 222 prior to DC power from first DC source 203 energizing dedicated circuit 102. Regardless, following interruption of AC power, third relay 410 directs DC power from dedicated circuit 102 to DC circuit 403. Under operating conditions wherein AC power energizes dedicated circuit 102, third relay 410 directs AC power to AC circuit 402. As noted, FIG. 5 also shows dedicated circuit current 123, which comprises AC power originating at AC power source 104 (shown in FIG. 1) or DC power originating at first DC source 203, depending, as discussed extensively herein, upon whether AC power from AC power source 104 is available.

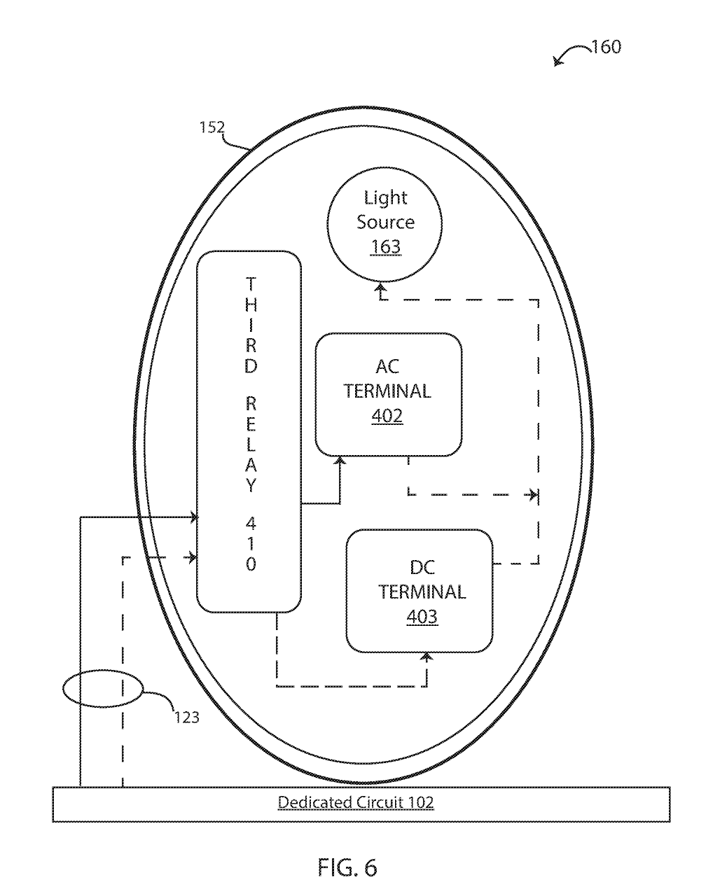

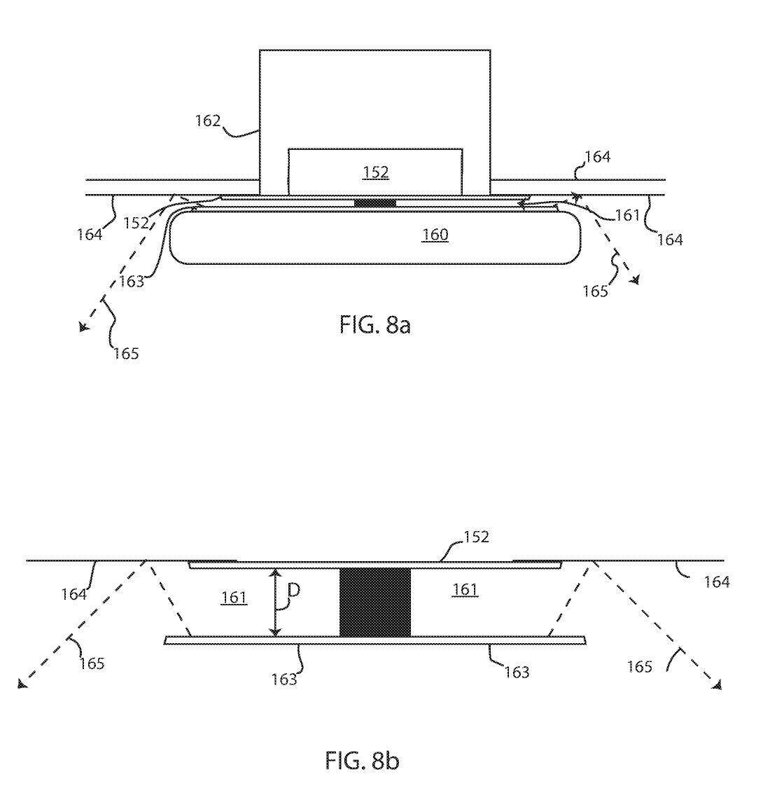

FIG. 6 is a schematic representation of an illumination device 160. FIG. 6 shows a back plate 152 and a light source 163. Light source 163, in some embodiments, is a fiber optic strand mounted on an exterior surface of illumination device 160, wherein light from light source 163 is reflected off a mounting surface into the surrounding building space, creating diffuse illumination of the space with reflected light. (See FIG. 8a-b.) This is by way of example, and not meant to be limiting. Additional examples of light source 163 include but are not limited to a light emitting diode (LED), fluorescent bulb, incandescent bulb, halogen bulb, laser, and the like.

In some embodiments, light source 163 generates green light. Test subjects placed in a dark room found illumination of the room with indirect green light to be more illuminative of a larger space when compared to illumination of the room with indirect white light. The green light provides illumination of a space to allow for safe egress of a person from the space, particularly under conditions wherein a primary source of illumination is absent, such as during a failure of the supply of AC line power to the building. In some embodiments, a plurality of illumination devices 160 are mounted in sequence to mark a route of building egress with a distinctive color light, such as a green color, for example. An occupant of a building space may find a path of egress from the space illuminated with colored light by an arrangement of illumination devices 160 along the path, even if the building's regular lighting is still functional and otherwise provides illumination of the space with white light.

Light source 163, in some embodiments, directs a light onto back plate 152 of alert device 160. Back plate 152, in some embodiments, is coupled to a building structure. In some embodiments, back plate 152 mounts directly to a standard commercially available electrical junction box, such as the type of junction box used to mount a light fixture, ceiling fan, or like electrical device to a ceiling of a building structure. This example is not meant to be limiting, in some embodiments, back plate 152 is mounted to an electrical junction box on a wall or any other structural element of a building. Such junction boxes are typically fastened directly to frame elements of a building, using fasteners such as by nails, screws, other fasteners, and the like.

FIG. 6 additionally shows AC circuit 402 and DC circuit 403 electrically coupled to third relay 410. In some embodiments wherein illumination device 160-comprises third relay 410, third relay 410 is electrically coupled to dedicated circuit 102 and electrically interposed between dedicated circuit 102 and both AC circuit 402 and DC circuit 403. AC circuit 402, in some embodiments, comprises any of many possible circuit means to modify an AC current conducted through dedicated circuit 102 to a DC current of suitable voltage to operate light source 163 and additional electrical components, in some embodiments. In some embodiments, AC circuit 402 comprises a voltage transformer. In some embodiments, AC circuit 402 comprises an AC to DC rectifier. In some embodiments, AC circuit 402 is electrically coupled to vibrational source 153. In some embodiments, AC circuit 402 is electrically coupled to DC circuit 402 which, in turn, is electrically coupled to light source 163. It is to be understood that many circuit configurations and electrical couplings are possible to create embodiments of illumination device 160 wherein either an incoming AC from dedicated circuit 102 or a DC from dedicated circuit 102 is used, whether modified or un-modified, to power light source 163.

FIG. 7 is a schematic representation of some alternative embodiments of illumination device 160 comprising multiple examples of possible detection and alert means. These examples are not meant to be limiting; illumination device 160 may comprise additional or alternative detection devices besides those examples noted in FIG. 7 and discussed herein below.

FIG. 7 shows alert device 160 comprising additional elements of battery interconnected illumination device system 100, present in some embodiments. In some embodiments, battery interconnected illumination device system 100 further comprises an emergency lighting system. The emergency lighting system is activated by DC power from first DC source 203 conducted through first relay 210 to alert device 160 following an interruption of AC power source 104, in some embodiments. In some embodiments, detection and alert device 160 comprises a visual alert 171. Visual alert communicates the presence of a condition, such as an emergency condition, to a person viewing visual alert 171. Visual alert 171 is distinguished from light source 163 in that visual alert 171, although visible to a person in a space, does not necessarily illuminate the space, wherein light source 163 does illuminate the space at a sufficient level for a person present in the space to safely exit the space, if necessary. Some non-limiting examples of visual alerts include a light source, such as a light-emitting diode, which is activated with activation of illumination device 160. In some embodiments, visual alert 171 is a flashing light. In some embodiments, visual alert 171 flashes in a pattern synchronous with pulsed vibrations of a vibrational alert caused by a vibration source 153. In some embodiments, visual alert 171 flashes in a pattern asynchronous with vibrations caused by vibration source 153.

As additionally shown in FIG. 7, in some embodiments, illumination device 160 comprises a smoke detector 173, such as a conventional smoke detection device. In some embodiments, illumination device 160 comprises a carbon monoxide detector 174, such as a conventional carbon monoxide detection device. In some embodiments, illumination device 160 comprises an intruder detector 175, such as a conventional motion detector or alternative intruder detection device. In some embodiments, illumination device 160 comprises a radon gas detector 177, such as a conventional radon gas detection device. In some embodiments, illumination device 160 comprises a communication link 178.

In some or all these embodiments, battery interconnected illumination device system 100 comprises a detection device, such as one of the aforementioned non-limiting examples of detection devices, to trigger a vibrational alert by activation of vibration source 153. Activation of vibration source 153 transmits a vibration to a building structure, as discussed herein above, and alerts a person in contact with the building structure to the existence of a possible emergency condition. Vibration source 153, in some embodiments, is coupled to the building structure through a mounting means, such as back plate 152 in some embodiments, coupling alert device 160 to the building structure. In some embodiments, alert device 160 is mounted on a conventional electrical junction box contained with a ceiling, a wall, or another component of the building structure. Vibrations arising from vibration source 153 are transmitted through alert device 160 via the mounting means to the ceiling, wall, or other building structure component throughout structural components of the building structure in physical continuity with alert device 160's location.

The effectiveness of the vibrations in waking a sleeping person is increased when the vibrations are intermittent and alternating with periods of no vibration, such as pulsed vibrations. Moreover, illumination device 160, in some embodiments, uses a pattern of pulsed vibrations to communicate the nature of an emergency situation to the person, and also to communicate at least simple instructions, such as remain in the room, immediately exit the building, etc. In some embodiments, a standardized language of patterned pulsed vibrations is used to communicate the nature of an emergency. In some embodiments, the standardized language is used to communicate instructions to a person.

In some embodiments, illumination device 160 comprises a communication link 178. Communication link 178 activates alert device 160, in some embodiments, when instructed to do so by a government public safety warning system, such as the Public Alert and Warning System operated by the United States Department of Homeland Security, for example. In some embodiments, communication link 178 is a wireless communication link. In some embodiments, communication link 178 is a wired communication link. In some embodiments, communication link 178 is activated by the NOAA Weather Radio All Hazards alert system. In some embodiments, other federal, state, and municipal government alert systems activate alert device 160 through communication link 178.

FIG. 8a is a side view of an illumination device 160 coupled to a mounting surface. FIG. 8b is an exploded side view of same. FIG. 8a-b shows illumination device 160, light source 163, back plate 152, a gap 161, a mounting surface 164, and a junction box 162. In some embodiments, illumination device 160 couples to junction box 162. In some embodiments junction box 162 is a standard electrical junction box. This is not, however, meant to be limiting. Junction box 162 comprises any housing coupled to a building and recessed into a building surface, such as a wall or ceiling, and provides a means wherein back plate 152 couples to a structural elements of the building surface. In some embodiments of battery interconnected illumination device system 100, mounting plate 152 is coupled directly to a building or other surface, such as an outdoor wall, or the like. FIG. 8a shows junction box 162 simply to illustrate a safe and effective means of coupling back plate 152 of illumination device 160 to a building surface. Other safe and effective means of coupling illumination device 160 to a surface are possible.

FIG. 8a-b additionally shows gap 161, formed by back plate 152 causing light source 161 of illumination device 160 to be offset from mounting surface 164. Gap 161 allows a direct light from light source 161 to be reflected from mounting surface 164 into a building or other space, creating a reflected light 165, as shown in FIG. 8. The size of gap 161 is represented by a distance “D.” D, in some embodiments, is determined by the intensity and color of light from light source 161. In some embodiments, D measures about one millimeter. In some embodiments, D measures up to about fifteen (15) centimeters. In some embodiments, D measures about 5 millimeters.

Reflected light 165, in some embodiments, is a green-colored light with a wavelength between about 470 nanometers and about 580 nanometers. Such a green colored light creates a soft glow within almost no perceptible glare, yet readily reflects off mounting surface 164, illuminating a relatively large space sufficient for a person present in the space to safely adequately visualize the space for safe egress.

Mounting surface 164, in some embodiments, is a painted surface, such as an interior or exterior building wall, or an interior building ceiling. Conventional paint such as that commonly used to paint interior and exterior surfaces of a building is often sufficiently reflective to cause most of light from light source 163 to become reflected light 165. In some embodiments, however, a reflective coating is coupled to mounting surface 164 to increase reflectivity of mounting surface 164.

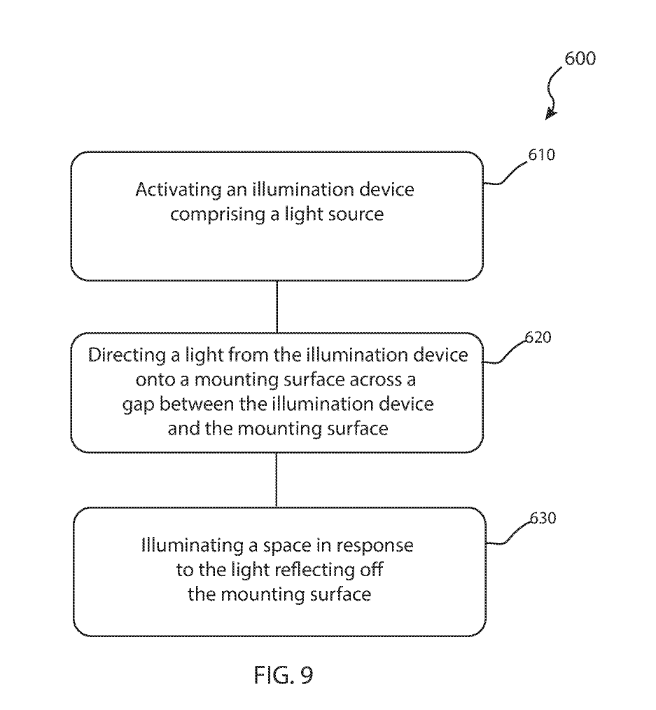

FIG. 9 is a schematic diagram of a method of creating a detection and alert device system. FIG. 9 shows a method 600 comprising an activating step 610, a directing step 620, and an illuminating step 630.

Activating step 610, in some embodiments, comprises activating an illumination device comprising a light source. In some embodiments under a condition wherein AC power is coupled to the illumination device, the AC power causes illumination of the light source, including illumination of the light source with rectified DC power originating from the AC power. In some embodiments, the illumination device is electrically coupled to a dedicated circuit, wherein electrical loads in the building separate from the illumination devices and alarm switches are not coupled to the dedicated circuit, electrically isolating the illumination devise and alarm switches from other electrical loads, in some embodiments.

Directing step 620, in some embodiments, comprises directing a light from the illumination device onto a mounting surface across a gap between the illumination device and the mounting surface. In some embodiments, directing step is achieved by a light source positioned on an exterior surface of the illumination device facing the mounting surface, wherein light from the light source shines across the gap directly onto the mounting surface, causing light to be reflected off of the mounting surface into a larger space, wherein the larger space is illuminated indirectly by the reflected light. In some embodiments, reflectivity of the mounting surface is increased by a reflective coating, such as a reflective paint or similar coating, coupled to the mounting surface.

In some embodiments, the light source is a circumferential light source, such as a solid plastic or glass thin “donut” which forms a generally elliptical shape on the exterior surface of the illumination device, causing light to be directed onto the mounting surface circumferentially around the perimeter of the illumination device. In some embodiments, the light source is a source of a colored light. In some embodiments, the colored light is a green light.

Illuminating step 630, in some embodiments, comprises illuminating a space in response to the light reflecting off the mounting surface. Illumination of the space is caused by the reflected light, which provides diffuse, indirect illumination to the space. The reflected light produces less glare than a direct light, causing illumination of an effectively larger space when contrasted to illumination of a space with non-reflected direct lighting.

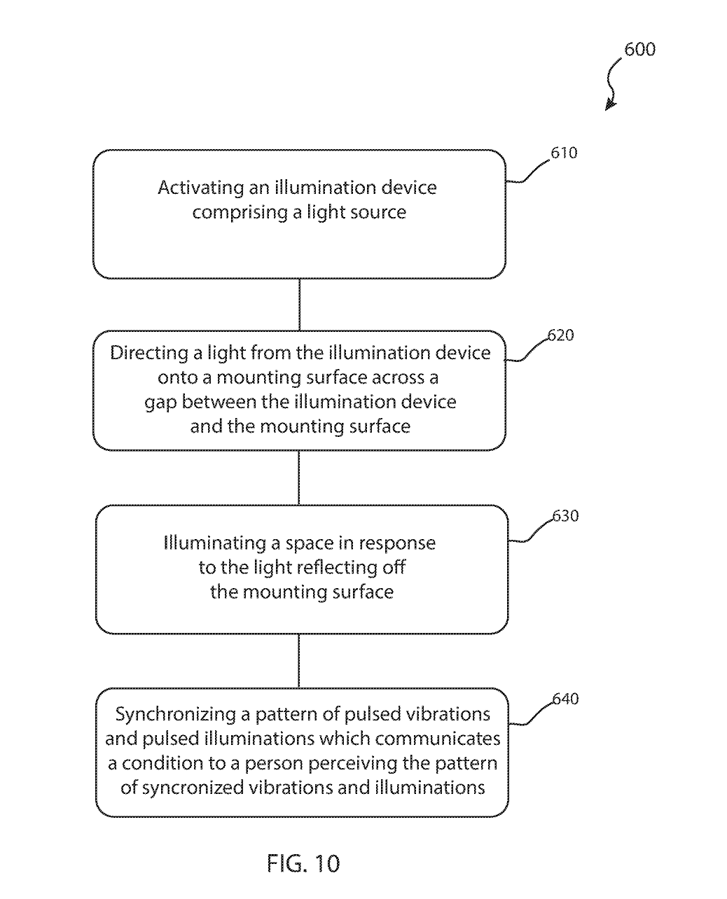

FIG. 10 is a schematic diagram of an additional embodiment of the method of creating a detection and alert device system. FIG. 10 shows method 600 further comprising a synchronizing step 640. In some embodiments, synchronizing step 640 of method 600 comprises synchronizing a pattern of pulsed vibrations and pulsed illuminations, wherein the illumination device comprises a pulsed vibrational source and wherein the light source is a pulsed light source, which communicates a condition to a person perceiving the synchronized pattern of pulsed vibrations caused by the pulsed vibrational source and the pattern or pulsed illuminations caused by the pulsed light source. In some embodiments, the pulsed vibrations and illuminations are in phase with one another. In some embodiments, the pulsed vibrations and illuminations are out of phase with one another in a regular phasic relationship. The foregoing examples of the regular phasic relationship between the pulsed vibrations and the pulsed illuminations are not meant to be limiting. The phase relationship between the pulsed vibrations and the pulsed illuminations may be anywhere on a continuous spectrum from completely in phase to completely out of phase. In some embodiments, the condition is an emergency condition. In some embodiments, the communication also includes instructions, according to a standard pattern of synchronized pulsed vibrations and illuminations.

A battery interconnected illumination device system has been described. The illumination device and system described herein provides a means for continuous, reliable DC backup of an interconnected network of illumination devices in or outside a building by locating a DC battery in a location convenient to the user, and, in some embodiments, by providing a means to continuously or intermittently recharge a rechargeable battery. It is to be understood that the embodiments of the battery interconnected illumination device and system according to the invention as shown and described is an example only and that many other embodiments of the battery interconnected illumination device and system according to the invention are possible and envisioned.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. An illumination device comprising:
a device comprising
a light source;
a first circuit powered by an alternating current;
a second circuit powered by a direct current electrically coupled to the light source,
a back plate coupled to the device; and
a gap interposed between the device and the back plate, wherein a light from the light source is directed across the gap onto a mounting surface coupled to the back plate, causing illumination of a space in response to directing the light onto the mounting surface.

2. The illumination device of claim 1, wherein the mounting surface is reflective.

3. The illumination device of claim 1, further comprising a dedicated circuit electrically coupled to the first circuit and to the second circuit.

4. The illumination device of claim 1, wherein the reflected light comprises a green light.

5. The reflective backup illumination device of claim 1, wherein the reflected light is a green light comprising a wavelength of between about 470 nanometers and about 580 nanometers.

6. The illumination device of claim 1, wherein the gap is between about one millimeter and about 15 centimeters.

7. The illumination device of claim 1, wherein the light source comprises an annular light source.

8. The illumination device of claim 1, wherein the device comprises a detection and alert device.

9. A method of use for an illumination device comprising the steps of:
activating an illumination device comprising a light source;
directing a light from the illumination device onto a mounting surface across a gap between the illumination device and the mounting surface; and
illuminating a space in response to the light reflecting off the mounting surface.

10. The method of claim 9, wherein the mounting surface comprises a reflective coating.

11. The method of claim 9, wherein the illumination device is coupled to a building structure comprising a dedicated circuit, wherein the illumination device is electrically coupled to the dedicated circuit.

12. The method of claim 9, further comprising a step synchronizing a pattern of pulsed vibrations and pulsed illuminations, wherein the illumination device comprises a pulsed vibrational source and wherein the light source is a pulsed light source, which communicates a condition to a person perceiving the synchronized pattern of pulsed vibrations caused by the pulsed vibrational source and the pattern or pulsed illuminations caused by the pulsed light source.

13. An illumination device system comprising:
an illumination device comprising a light source;
an alert device; and
a mounting surface, wherein the illumination device directs a light from the light source onto the mounting surface forming a reflected light, causing illumination of a space with the reflected light.

14. The illumination device system of claim 13, wherein the alert device comprises a visual alert.

15. The illumination device of claim 14, wherein the visual alert is a pulsed visual alert.

16. The illumination device system of claim 13, wherein the alert device comprises a vibrational alert.

17. The illumination device system of claim 16, wherein the vibrational alert is a pulsed vibrational alert.

18. The illumination device system of claim 13, comprising a pulsed visual alert and a pulsed vibrational alert, wherein the pulsed visual alert is synchronous with the pulsed vibrational alert.

19. The illumination device system of claim 13, wherein the alert device comprises an auditory alert.

20. The illumination device system of claim 13, wherein the illumination device comprises a detection and alert device.

21. An illumination system comprising:
a dedicated circuit electrically coupled to an alternating current and a direct current, wherein under a condition with the alternating current present, the dedicated circuit is energized with the alternating current;
a first relay electrically coupled to each of the dedicated circuit, the alternating current, and the direct current, wherein under a condition with the alternating current absent, the first relay causes the direct current to energize the dedicated circuit;
an illumination device electrically coupled to the dedicated circuit, comprising
a light source;
a first circuit powered by the alternating current;
a second circuit electrically coupled to each of the first circuit and the light source, wherein the second circuit energizes the light source;
a back plate coupled to the illumination device; and
a gap interposed between the illumination device and the back plate, wherein the gap separates the illumination device from a mounting surface, and wherein a light from the light source is directed across the gap onto the mounting surface and reflected by the mounting surface, causing illumination of a space with a reflected light.

22. The illumination system of claim 21, wherein a battery coupled to the dedicated circuit energizes the dedicated circuit with the direct current.

23. The illumination system of claim 21, further comprising
a detection and alert device electrically coupled to the dedicated circuit;
a plurality of illumination devices electrically coupled to the dedicated circuit, and
a low voltage controller coupled to the dedicated circuit, wherein the low voltage controller responds to activation of the detection and alert device by activating the plurality of backup illumination devices.
